(19) United States
(12) Patent Application Publication
(10) Pub. No.: US 2012/0166658 A1
(43) Pub. Date: Jun. 28, 2012

(54) GMPLS NETWORK-BASED INTER-DOMAIN INTERFACE APPARATUS AND METHOD

(75) Inventors: Ki-Won KIM, Daejeon-si (KR); Ho-Young SONG, Daejeon-si (KR)

(73) Assignee: Electronics and Telecommunications Research Institute, Daejeon-si (KR)

(21) Appl. No.: 13/334,795

(22) Filed: Dec. 22, 2011

(30) Foreign Application Priority Data
Dec. 22, 2010 (KR) 10-2010-0132725

(51) Int. Cl. G06F 15/16

(52) U.S. Cl. 709/228

(57) ABSTRACT

A general multiprotocol label switching (GMPLS) network-based inter-domain interface apparatus and apparatus are provided. The GMPLS network-based inter-domain interface apparatus is installed in an edge node of a GMPLS network-based inter-domain, forms a session between edge nodes of the inter-domains, and allows the edge nodes to exchange a routing protocol message. Accordingly, link state information and routing information can be automatically exchanged in real time between inter-domains.

### CROSS-REFERENCE TO RELATED APPLICATION(S)

This application claims the benefit under 35 U.S.C. §119(a) of Korean Patent Application No. 10-2010-0132725, filed on Dec. 22, 2010, in the Korean Intellectual Property Office, the entire disclosure of which is incorporated herein by reference for all purposes.

### BACKGROUND

1. Field

The following description relates to a routing protocol processing technique, and more particularly, to a general multiprotocol label switching (GMPLS) network-based inter-domain interface apparatus and method.

2. Description of the Related Art

Conventionally, to aggregate and exchange link state information and routing information in a single domain of a general multiprotocol label switching (GMPLS) network consisting of devices supporting GMPLS, interior gateway protocol (IGP) including intermediate system to intermediate system (IS-IS) protocol and open shortest path first (OSPF) protocol is extended for use as a standard protocol for exchanging node identifier (ID), link interface ID, link state information, traffic engineering (TE) information, and the like.

This is a scheme to collect and exchange link state information and routing information based on IGP routing protocol, which is limited to a single domain region. A GMPLS-based core or a backbone network may adopt a method to aggregate and manage link state information of adjacent paths by individual operators under the agreement about the adjacent paths between providers in an effort to provide a service of a path between subscriber domains or between different domains.

In this method, link state information is manually aggregated and managed by the operator once it was initially collected, and thus there may be a difficulty in continuously updating link state information in real time, which varies with the increase in complexity in a network between domains and the increase of links of connection between domains.

### SUMMARY

The following description relates to a general multiprotocol label switching (GMPLS) network-based inter-domain interface apparatus and method for allowing exchange link state information and routing information automatically in real time between inter-domains in a GMPLS network.

In one general aspect, there is provided a general multiprotocol label switching (GMPLS) network-based inter-domain interface apparatus which is installed on a GMPLS network-based inter-domain edge node and allows information to be exchanged between inter-domains, the inter-domain interface apparatus including: a routing protocol processing unit configured to establish a session to another inter-domain edge node and exchange a routing protocol message with the inter-domain edge node; and an operation information storing unit configured to store information required for operation of the routing protocol processing unit.

Other features and aspects may be apparent from the following detailed description, the drawings, and the claims.

### BRIEF DESCRIPTION OF THE DRAWINGS

FIG. 1 is a diagram illustrating a single domain network (e.g., autonomous system (AS)) that uses intermediate system to intermediate system (IS-IS) protocol.

FIG. 2 is a diagram illustrating an example of GMPLS networks which exchange inter-domain link state information and routing information therebetween using IS-IS routing protocol.

FIG. 3 is a diagram illustrating an example of a GMPLS network-based inter-domain interface apparatus.

FIG. 4 is a flowchart illustrating an example of a GMPLS based inter-domain interface method.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

User network interface (UNI) standard interface has been introduced for setting a connection and exchanging link state information between different domains in an effort to provide a subscriber service in a general multiprotocol label switching (GMPLS) network, and the GMPLS network supports mutually different types of connection control.

Such types includes permanent connection (PC) that manually establishes a inter-domain connection, soft permanent connection (SPC) that establishes inter-domain on demand by an operator, and switched connection (SC) that establishes inter-domain connection through routing protocol exchange.

Among the above types, only SC uses a UNI standard interface to exchange information necessary for inter-domain connection control. The SC scheme provides a standard interface for connection control between domains in different subscriber networks to exchange link state information therebetween or establish a connection, whereas other connection control schemes allow an operator to establish a connection and exchange link state information between domains in different subscriber network according to a non-standard scheme.

According to intermediate system to intermediate system (IS-IS) protocol, link state information and routing information are exchanged in a single domain. The IS-IS protocol is a dynamic routing interior gateway protocol (IGP) that is designed for establishing a path between routers using an open systems interconnection (OSI) protocol in a connectionless mode network service (CLNS) environment.

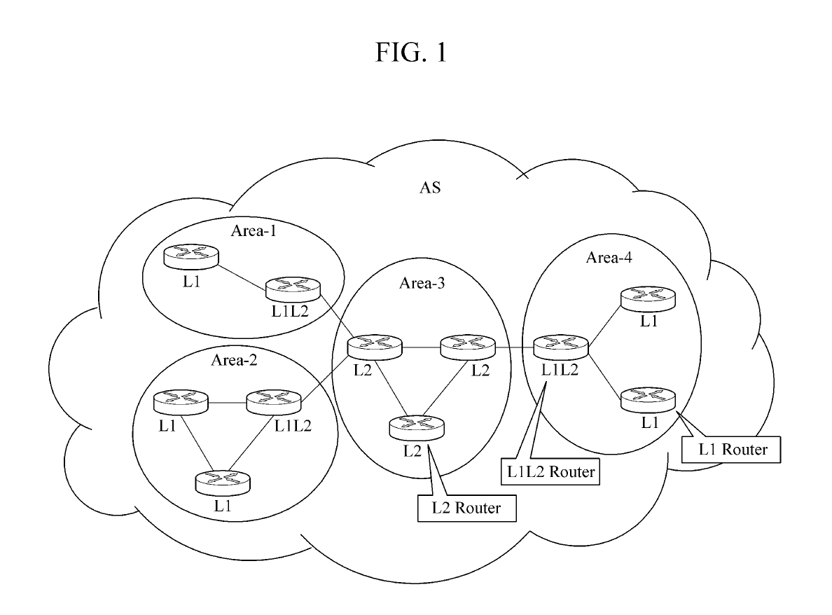

FIG. 1 illustrates a diagram of a single domain network (e.g., autonomous system (AS)) that uses IS-IS protocol. Referring to FIG. 1, for convenience of operation, the network is divided into different areas, each of which has a dedicated router to manage link state information and routing information of each area.

IS-IS protocol refers a routing node (router) as an intermediate system (IS), a host as an end system (ES), and a connection between nodes as adjacency, and may provide protocol between a host and a router and a protocol between routers.

In addition, IS-IS protocol may be referred to as integrated IS-IS routing protocol that supports simultaneous transmission of CLNS routing information and IP prefixes.

From the network viewpoint, IS-IS network nodes are classified into a Level 1 node (L1), a Level-2 node (L2), and a Level-1/2 node (L1L2). The Level 1 node only exchanges link state information of a corresponding area with other Level 1 nodes and manages the link state information, and the link state information is referred to as Level 1 routing information.

The Level 2 or Level-1/2 node which is a router placed adjacent to a border of the area, manages link state information of an area to which the router itself is belonging and exchanges the link state information and link state information of another area, which is referred to as 1/2 routing information.

A network using IS-IS protocol consists of a Level 2 node for connecting different areas, a Level 1 node for interconnecting the area, and a Level 1/2 node for connecting both the Level 2 node and the Level 1 node.

Routers of IS-IS network forms adjacency by transmitting and receiving hello packets therebetween, and then builds a link-state database (LSDB) by exchanging the link state information and routing information via link state PDU (LSP). Based on the built LSDB, a routing table is made using the shortest path algorithm.

Unlike link state adjacency (LSA) of open shortest path first (OSPF) that is also IGP routing protocol, IS-IS protocol simplifies information into an integrated link state packet (LSP), and transmits the simplified packet. Accordingly, even in a complex network, link state information and routing information can be effectively updated, and thus IS-IS network is used as a core network or a backbone network.

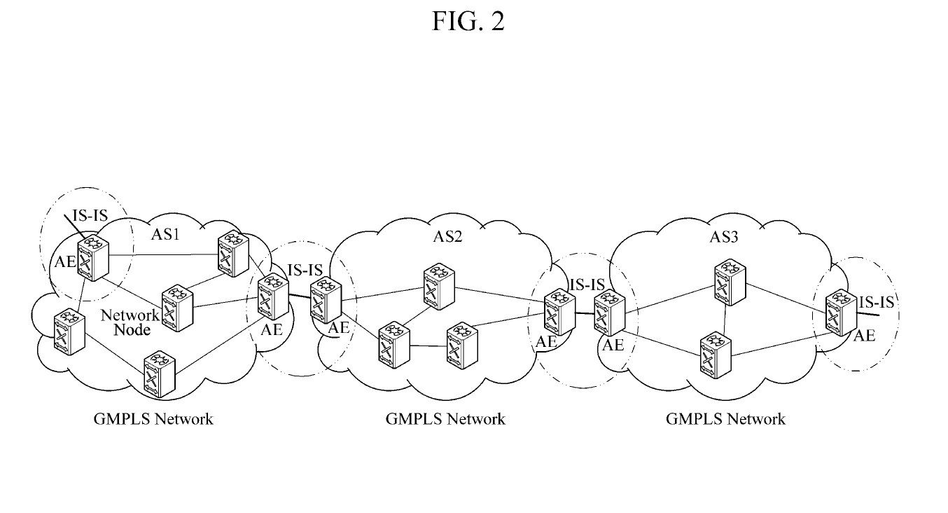

In the example, GMPLS networks are allowed to exchange inter-domain link state information and routing information therebetween using IS-IS routing protocol. FIG. 2 illustrates a diagram of an example of GMPLS networks which exchange inter-domain link state information and routing information therebetween using IS-IS routing protocol.

Referring to FIG. 2, a network apparatus that supports a general multiprotocol label switching (GMPLS) control function is referred to as a GMPLS network node, a network consisting of a number of GMPLS network nodes is referred to as a GMPLS-based network, and a system in which the GMPLS-based network forms one administrative domain is referred to as an autonomous system (AS). A network may be formed between adjacent ASes, that is, between different administrative domains, and each of the GMPLS networks operates independently under the control of individual operators.

As shown in FIG. 2, an inter-domain GMPLS network is formed by adjoining different ASes, for exchange adjacent link information and routing information between adjacent GMPLS inter-domains, an inter-domain interface apparatus is provided to each of AS edge nodes AE for connecting ASes.

Initial setting of the inter-domain interface apparatus in the GMPLS network-based inter-domain edge node AE is performed by an operator according to agreements between service providers or network operators.

The inter-domain interface apparatus is provided to the GMPLS network-based inter-domain edge node AE establishes a session between the inter-domain edge nodes AEs to form adjacency by executing the routing protocol process for exchanging link state information and routing information between inter-domains, and exchanges routing protocol messages for inter-domain connection using IS-IS routing protocol.

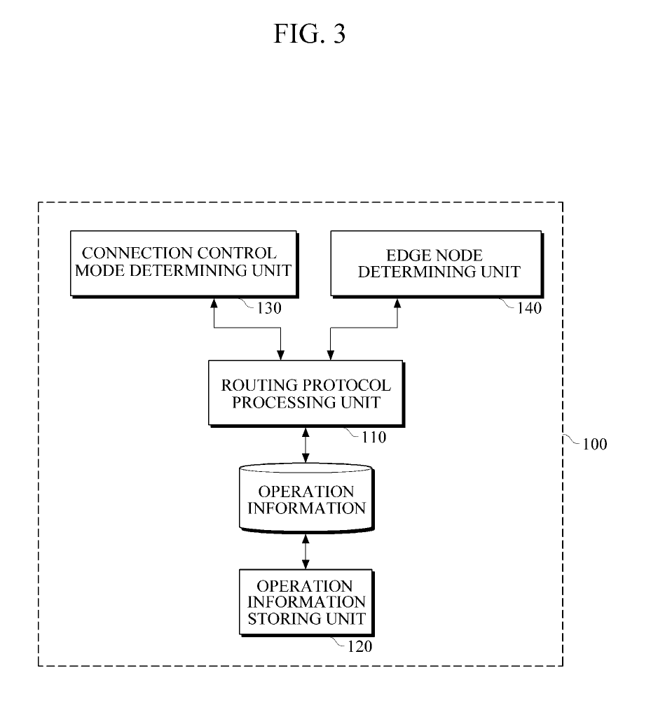

FIG. 3 illustrates a diagram of an example of a GMPLS network-based inter-domain interface apparatus. The GMPLS network-based inter-domain interface apparatus 100 shown in the example illustrated in FIG. 3 may be installed in a GMPLS network-based inter-domain edge node to exchange information between inter-domains, and include a routing protocol processing unit 110 and an operation information storing unit 120.

The routing protocol processing unit 110 may establish a session between inter-domain edge nodes to exchange routing protocol messages. In this case, the routing protocol processing unit 110 may exchange the routing protocol messages using intermediate system to intermediate system (IS-IS) routing protocol.

The operation information storage unit 120 may store operation information containing information required for operating the routing protocol processing unit 110. The operation information is used to operate IS-IS routing protocol between the inter-domain edge nodes, and may be, for example, information for determining whether or not to install and operate the IS-IS routing protocol processing unit 110 for exchanging link state information between inter-domains. The operation information needs to be defined by agreement between domain operators prior to operating of IS-IS routing protocol between inter-domains.

For example, as shown in a table below, the operation information may include domain identifier (ID), an edge node AE, network ID, access interface information, and AE IS-IS interface flag.

| Information | Description |
|---|---|
| Domain ID | User Network ID, AS(Autonomous System) Number |
| AE Network ID | ID of connected node of adjacent domain |
| Access Interface | Information about Physical Interface Accessed by AS |
| Information | AEs, Location Information of Rack-Shelf-Slot-Port |
| | and the Like |
| AE IS-IS | Availability of AE IS-IS (Active/Inactive) |
| Interface Flag | |

Security and authentication information of adjacent domains is more like a policy that is determined by agreement between the service providers, and is not taken into consideration when operating the inter-domain IS-IS routing protocol.

The routing protocol processing unit 110 operates the IS-IS routing protocol based on the operation information stored in the operation information storage unit 120 to establish an inter-domain session, and exchanges link state information and routing information between inter-domains in real time.

For example, when the AE IS-IS interface flag value is “active,” the routing protocol processing unit 110 may connect a session between inter-domains by operating the IS-IS routing protocol and exchange hello packets to confirm the normal operation of inter-domain AEs, and then link state information and routing information can be exchanged between inter-domains in real time.

Thus, the aforementioned GMPLS network-based inter-domain interface apparatus 100 may allow establishing a session between the inter-domain edge nodes and exchanging routing protocol messages through the session, and thereby enabling the GMPLS network-based inter-domains to exchange the link state information and the routing information in real time in.

In another example, the GMPLS network-based inter-domain interface apparatus 100 may further include a connection control mode determining unit 130. The connection control mode determining unit 130 may determine an inter-domain connection control mode.

The connection control mode determining unit 130 may be designed to determine the inter-domain connection control mode from connection control mode information that is defined in the operation information stored in the operation information storage unit 120.

The connection control mode may be one of permanent connection mode for manually setting an inter-domain connection, soft permanent connection mode for setting an inter-domain connection by demand of an operator, and switched connection mode for setting an inter-domain connection by exchanging routing protocols.

If the connection control mode determining unit 130 determines permanent connection mode or soft permanent connection, the GMPLS network-based inter-domain interface apparatus 100 may establish a session between inter-domain edge nodes by driving the routing protocol processing unit 110 and allowing the inter-domain edge nodes to exchange the routing protocol messages through the session.

If the connection control mode determining unit 130 determines switched connection mode, the GMPLS network-based inter-domain interface apparatus 100 may form a session between inter-domain edge nodes by driving the routing protocol processing unit 110, and determine whether to exchange routing protocol messages or to exchange information required for GMPLS domain connection control using a standard interface.

In another example, the GMPLS network-based inter-domain interface apparatus 100 may further include an edge node determining unit 140. The edge node determining unit 140 may determine an edge node.

The GMPLS network-based inter-domain interface apparatus 100 designed to operate on the edge node uses the edge node determining unit 140 to determine whether the apparatus 100, itself, is installed in an inter-domain edge node, and, if the edge node determining unit 140 determines the node as an inter-domain edge node, drives the routing protocol processing unit 110 to form a session between inter-domains, allowing routing protocol messages to be exchanged through the session.

In another example, the edge node determining unit 140 may be configured to further determine whether the apparatus 100 is set as an inter-domain interface. Even when the GMPLS network-based inter-domain interface apparatus 100 is installed in the inter-domain edge node, if the edge node IS-IS interface flag value is set as Inactive, the apparatus 100 is not enabled to function as an inter-domain interface.

Thus, the GMPLS network-based inter-domain interface apparatus 100 uses the edge node determining unit 140 to determine whether the apparatus 100, itself, is set as an inter-domain interface. If it is determined that the apparatus 100 is set as an inter-domain interface, the apparatus 100 drives the routing protocol processing unit 110 to establish a session between inter-domain edge nodes, and exchanges routing protocol messages.

In another example, the routing protocol processing unit 110 may be configured to be driven to search for other edge nodes from nodes within or outside of inter-domains when the edge node determining unit determines that the apparatus 100 is installed on an edge node.

In this case, the routing protocol processing unit 110 may establish a session with the found edge node, and transmit a hello packet to the found edge node through the session to confirm adjacency between inter-domains.

The routing protocol processing unit 110 may be configured to exchange routing protocol messages including link state information and routing information with the other edge node.

Accordingly, the routing protocol processing unit 110 allows a physical network connection between the inter-domain edge node and the other edge node, and allows link state information and routing information to be exchanged between the inter-domain edge node and the other edge node using IS-IS routing protocol.

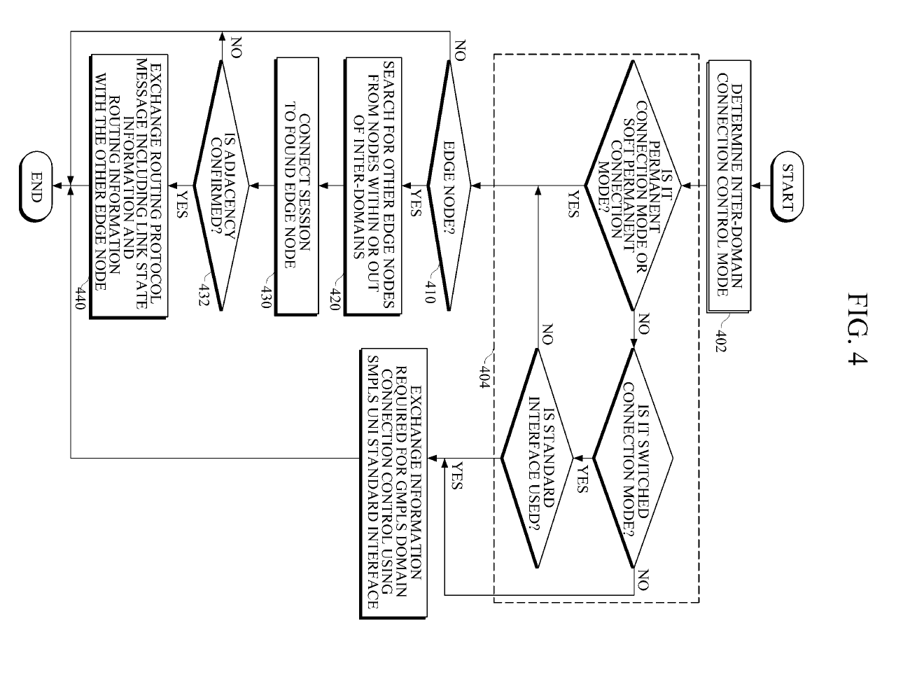

The operation of the GMPLS network-based inter-domain interface apparatus will be described with reference to FIG. 4. FIG. 4 illustrates a flowchart of an example of a GMPLS based inter-domain interface method.

In operation 410, it is determined whether a GMPLS network-based inter-domain interface apparatus is an edge node. In this operation, it may be further determined whether the GMPLS network-based inter-domain interface apparatus is set as an inter-domain interface. In this regard, the detailed description is described above, and thus will not be reiterated.

Then, in operation 420, other edge nodes are searched for from nodes within or outside of the inter-domains, and it has been described above, and thus will not be reiterated.

In operation 430, the GMPLS network-based inter-domain interface apparatus connects a session to the other edge node found in operation 420.

Thereafter, in operation 440, the GMPLS network-based inter-domain interface apparatus exchanges routing protocol messages including link state information and routing information with the found other edge node.

In operation 440, the GMPLS network-based inter-domain interface apparatus exchanges the routing protocol messages with the other edge node using IS-IS routing protocol.

Therefore, the GMPLS network-based inter-domain interface apparatus installed on the GMPLS network-based inter-domain edge node establishes a session between the inter-domain edge nodes, and allows the edge nodes to exchange routing protocol messages through the session, and thus the link state information and the routing information can be automatically exchanged in real time between the GMPLS network-based inter-domains.

In another example, the GMPLS based inter-domain interface method may further include determining of connection control mode and determining of a message exchange scheme.

In operation 402, the GMPLS network-based inter-domain interface apparatus determines an inter-domain connection control mode. In this case, the connection control mode may be one of permanent connection mode for manually setting an inter-domain connection, soft permanent connection mode for setting an inter-domain connection by demand of an operator, and switched connection mode for setting an inter-domain connection by exchanging routing protocols.

Then, in operation 404, the GMPLS network-based inter-domain interface apparatus is determined as being in switched connection mode in operation 402, it is determined whether to exchange a routing protocol message using IS-IS routing protocol or to exchange information required for GMPLS domain connection control using a GMPLS user-network interface (UNI) standard interface.

If the connection control mode is determined as permanent connection mode or soft permanent connection mode in operation 402, it is determined that the routing protocol message is to be exchanged using IS-IS routing protocol in operation 404.

In another example, the GMPLS based inter-domain interface method may further include confirming of adjacency. The adjacency between inter-domains is confirmed in operation 432 prior to operation 440 by transmitting a hello packet to the other edge node to which a session has been connected in operation 430. The hello packet is a message to be exchanged for confirming if the session is normally connected before exchanging routing protocol messages.

Then, in operation 440, the GMPLS network-based inter-domain interface apparatus exchanges the routing protocol message with the other edge node when the adjacency with the edge node has been confirmed in operation 432.

As described above, the GMPLS network-based inter-domain interface apparatus installed on a GMPLS network-based inter-domain edge node establishes a session between inter-domain edge nodes, and allows routing protocol messages to be exchanged through the session, and thereby link state information and routing information can be automatically exchanged in real time between GMPLS network-based inter-domains.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A general multiprotocol label switching (GMPLS) network-based inter-domain interface apparatus which is installed on a GMPLS network-based inter-domain edge node and allows information to be exchanged between inter-domains, the inter-domain interface apparatus comprising:
a routing protocol processing unit configured to establish a session to another inter-domain edge node and exchange a routing protocol message with the inter-domain edge node; and
an operation information storing unit configured to store information required for operation of the routing protocol processing unit.

2. The GMPLS network-based inter-domain interface apparatus of claim 1, further comprising:
a connection control mode determining unit configured to determine inter-domain connection control mode.

3. The GMPLS network-based inter-domain interface apparatus of claim 2, wherein the connection control mode determining unit is further configured to determine the inter-domain connection control mode from connection control mode information specified in the operation information that is stored in the operation information storage unit.

4. The GMPLS network-based inter-domain interface apparatus of claim 2, wherein the connection control mode is one of permanent connection mode for manually setting an inter-domain connection, soft permanent connection mode for setting an inter-domain connection by demand of an operator, and switched connection mode for setting an inter-domain connection by exchanging routing protocols.

5. The GMPLS network-based inter-domain interface apparatus of claim 1, further comprising:
an edge node determining unit configured to determine whether the GMPLS network-based inter-domain interface apparatus is an edge node.

6. The GMPLS network-based inter-domain interface apparatus of claim 5, wherein the edge node determining unit is further configured to further determine whether the GMPLS network-based inter-domain interface apparatus is set as an inter-domain interface.

7. The GMPLS network-based inter-domain interface apparatus of claim 5, wherein the routing protocol processing unit is operated to search for another edge node from nodes within or outside of inter-domains when the edge node determining unit determines that the GMPLS network-based inter-domain interface apparatus is an edge node.

8. The GMPLS network-based inter-domain interface apparatus of claim 7, wherein the routing protocol processing unit is further configured to connect a session to the found edge node and transmit a hello packet to the connected edge node to confirm adjacency between inter-domains.

9. The GMPLS network-based inter-domain interface apparatus of claim 8, wherein the routing protocol processing unit is further configured to exchange a routing protocol message including link state information and routing information with the edge node which has been confirmed with respect to the adjacency.

10. The GMPLS network-based inter-domain interface apparatus of claim 1, wherein the routing protocol processing unit is further configured to exchange the routing protocol message using intermediate system to intermediate system (IS-IS) routing protocol.

11. A general multiprotocol label switching (GMPLS) network-based inter-domain interface method comprising:
determining whether a GMPLS network-based inter-domain interface apparatus is an edge node or not;
searching for another edge node from nodes within or outside of inter-domains when it is determined that the GMPLS network-based inter-domain interface apparatus is an edge node;
connecting, at the GMPLS network-based inter-domain interface apparatus, a session to the found other edge node; and
exchanging, at the GMPLS network-based inter-domain interface apparatus, a routing protocol message including link state information and routing information with the connected edge node.

12. The GMPLS network-based inter-domain interface method of claim 11, wherein the exchanging of the routing protocol message comprises exchanging the routing protocol message using intermediate system to intermediate system (IS-IS) routing protocol.

13. The GMPLS network-based inter-domain interface method of claim 12, further comprising:
determining, at the GMPLS network-based inter-domain interface apparatus, an inter-domain connection control mode; and
when the GMPLS network-based inter-domain interface apparatus determines that the connection control mode is switched connection mode, determining whether to exchange the routing protocol message using IS-IS routing protocol or to exchange information required for control of connection between GMPLS domains using a GMPLS user network interface (UNI) standard interface.

14. The GMPLS network-based inter-domain interface method of claim 11, further comprising:
prior to exchanging the routing protocol message, confirming adjacency between inter-domains by transmitting a hello packet to the other edge node to which the session has been connected.

15. The GMPLS network-based inter-domain interface method of claim 14, wherein the exchanging of the routing protocol message comprises exchanging, at the GMPLS network-based inter-domain interface apparatus, the routing protocol message to the edge node that has been confirmed with respect to the adjacency.

16. The GMPLS network-based inter-domain interface method of claim 11, wherein the determining of whether the GMPLS network-based inter-domain interface apparatus is an edge node comprises further determining whether the GMPLS network-based inter-domain interface apparatus is set as an inter-domain interface.
